(19) United States
(12) Patent Application Publication
(10) Pub. No.: US 2016/0328802 A1
(43) Pub. Date: Nov. 10, 2016

(54) SYSTEM AND METHOD FOR DETERMINING MERCHANT REVENUE USING TRANSACTION DATA AND GEOTEMPORAL DATA

(71) Applicant: MasterCard International Incorporated, Purchase, NY (US)

(72) Inventor: Justin X. Howe, San Francisco, CA (US)

(21) Appl. No.: 14/708,020

(22) Filed: May 8, 2015

(51) Int. Cl. G06Q 40/00

(52) U.S. Cl. CPC G06Q 40/12

(57) ABSTRACT

A computer-implemented method for determining merchant revenue using transaction data and geotemporal data is provided. The method includes receiving a revenue report request message generated by a requesting party, the revenue report request message including a merchant identifier and a report period. The method also includes receiving transaction data for the merchant associated with the merchant location from a payment processing network and receiving geotemporal data for a geographic region including the merchant location. The method further includes analyzing the geotemporal data to determine a number of visitors located at the merchant location during the report period. The method still further includes calculating a revenue share using the transaction data and the number of visitors, and providing a revenue report to the requesting party, the revenue report including the revenue share.

### BACKGROUND OF THE DISCLOSURE

The field of the invention relates generally to determining merchant revenue, more particularly, to the use of payment card transaction data and geotemporal data to determine merchant revenue of particular merchant location.

In today's business world, many decisions are made based on information products. Information products are collections of data that are analyzed and represented in useful ways for the variety of businesses that rely on them. They reveal consumer trends, financial trends, regional and demographic information, and much more. The more accurate and truly representational of the sample population about which they are produced, the more useful information products can be—and the more businesses will want to purchase and utilize them.

For example, payment processing companies (e.g., MasterCard®, VISA®, American Express®, and First Data Corp.®) want to determine their respective share of transactions initiated at a particular merchant location, in part to then estimate the total revenue generated at the merchant location—and the share of said revenue generated by their cardholders. The current method of estimating a percentage share of revenue from cardholders of the various payment card processing companies includes purchasing regional credit card information from credit-reporting agencies such as Experian®. This information provides the number of American Express®, VISA®, and MasterCard® credit cards issued in a particular zip code or set of zip codes. From this information, the relative share or ratio of the credit-card based transactions in that particular zip code or area related to the set of zip codes are inferred.

It is clear that this method of estimating the respective share of transactions attributable to each payment processing company is limited in its accuracy. The same estimate of percentage share is used at every merchant location in the area or zip code. Moreover, none of cash, check, and debit card data is available from any particular agency, so that data, too, must be assumed, which only compounds the potential error in these estimates. Accordingly, the information product that results, namely the estimation of merchant revenue, is limited in its value.

### BRIEF DESCRIPTION OF THE DISCLOSURE

In one aspect, a computer-implemented method determining merchant revenue using transaction data and geotemporal data is provided. The method is implemented using a revenue determination computing device. The method includes receiving, at the revenue determination computing device, a revenue report request message generated by a requesting party, the revenue report request message including a merchant identifier and a report period. The merchant identifier associates a merchant with a merchant location. The method also includes receiving transaction data for the merchant associated with the merchant location from a payment processing network. The transaction data includes a plurality of payment card transactions initiated during the report period by cardholders with the merchant, each payment card transaction having an associated transaction amount. The method further includes receiving geotemporal data for a geographic region including the merchant location. The geotemporal data is extracted from signals emitted from a plurality of mobile devices located within the geographic region during the report period. The method further includes analyzing the geotemporal data to determine a number of visitors located at the merchant location during the report period. A visitor is associated with a mobile device that is located at the merchant location during the report period. The method also includes calculating a revenue share using the transaction data and the number of visitors. The revenue share represents a share of merchant revenue generated by cardholders having payment cards associated with the payment processing network. The method still further includes providing a revenue report to the requesting party, the revenue report including the revenue share.

In another aspect, a merchant valuation computer system for determining merchant revenue using transaction data and geotemporal data is provided. The merchant valuation computer system includes a memory and a revenue determination computing device including a processor. The processor is configured to receive a revenue report request message generated by a requesting party. The revenue report request message includes a merchant identifier and a report period. The merchant identifier associates a merchant with a merchant location. The processor is further configured to receive the transaction data for the merchant associated with the merchant location from a payment processing network. The transaction data includes a plurality of payment card transactions initiated during the report period by cardholders with the merchant, each payment card transaction having an associated transaction amount. The processor is also configured to receive the geotemporal data for a geographic region including the merchant location. The geotemporal data is extracted from signals emitted from a plurality of mobile devices located within the geographic region during the report period. The processor is further configured to analyze the geotemporal data to determine a number of visitors located at the merchant location during the report period. A visitor is associated with a mobile device that is located at the merchant location during the report period. The processor is configured to calculate a revenue share using the transaction data and the number of visitors. The revenue share represents a share of merchant revenue generated by cardholders having payment cards associated with the payment processing network. The processor is still further configured to provide a revenue report to the requesting party, the revenue report including the revenue share.

In yet another aspect, computer-readable media having computer-executable instructions embodied thereon for determining merchant revenue using transaction data and geotemporal data is provided. When executed by at least one processor, the computer-executable instructions cause the processor to receive a revenue report request message generated by a requesting party. The revenue report request message includes a merchant identifier and a report period. The merchant identifier associates a merchant with a merchant location. When executed by at least one processor, the computer-executable instructions further cause the processor to receive the transaction data for the merchant associated with the merchant location from a payment processing network. The transaction data includes a plurality of payment card transactions initiated during the report period by cardholders with the merchant, each payment card transaction having an associated transaction amount. When executed by at least one processor, the computer-executable instructions also cause the processor to receive the geotemporal data for a geographic region including the merchant location. The geotemporal data is extracted from signals emitted from a plurality of mobile devices located within the geographic region during the report period. When executed by at least one processor, the computer-executable instructions further cause the processor to analyze the geotemporal data to determine a number of visitors located at the merchant location during the report period. A visitor is associated with a mobile device that is located at the merchant location during the report period. When executed by at least one processor, the computer-executable instructions cause the processor to calculate a revenue share using the transaction data and the number of visitors. The revenue share represents a share of merchant revenue generated by cardholders having payment cards associated with the payment processing network. When executed by at least one processor, the computer-executable instructions still further cause the processor to provide a revenue report to the requesting party, the revenue report including the revenue share.

### BRIEF DESCRIPTION OF THE DRAWINGS

FIGS. 1-10 show example embodiments of the methods and systems described herein.

FIG. 1 is a schematic diagram illustrating an example multi-party payment card industry system for enabling payment-by-card transactions in accordance with the present disclosure;

FIG. 2 is a simplified block diagram of an example merchant valuation system for processing payment card transaction data and geotemporal data in accordance with one embodiment of the present disclosure;

FIG. 3 illustrates an example configuration of a client device shown in FIG. 2;

FIG. 4 illustrates an example configuration of a server system shown in FIG. 2;

FIG. 5 is a data flow diagram showing the flow of data between a revenue determination computing device, a payment processor, and a geotemporal network server within an example merchant valuation system shown in FIG. 2;

FIG. 6 illustrates an example revenue determination computing device shown in FIG. 1;

FIG. 7 is a flow chart illustrating the categorization of mobile devices performed using the merchant valuation system shown in FIG. 2;

FIG. 8 illustrates another example revenue determination computing device shown in FIG. 1;

FIG. 9 shows an example grouping of a population for an example scaling factor used by the revenue determination computing device shown in FIGS. 6 and 8; and

FIG. 10 shows a component view of an example revenue determination computing device shown in FIG. 1.

Like numbers in the Figures indicate the same or functionally similar components.

### DETAILED DESCRIPTION

Some methods for determining the share of merchant revenue attributable to a particular payment processing company leverage the above-described credit-reporting information with institution-particular knowledge of cardholder activity at the merchant location. For example, payment processing company A knows that ten transactions were made by cardholders using a credit card associated with payment processing company A at a particular merchant location, with these ten transactions totaling revenue of $1,000. From the credit-reporting information, payment processing company A also knows that 25% of the credit cards in the region (a particular set of zip codes) are credit cards associated with payment processing company A (the balance being credit cards associated with payment processing company B and/or associated with payment processing company C, for example). Payment processing company A may then infer that the ten transactions at the merchant location are only 25% of the total credit-card transactions at that merchant location. Thus, payment processing company A may estimate that 40 credit-card transactions were performed at the merchant location. Payment processing company A may further infer that the $1,000 of revenue it recorded for the merchant location is only 25% of the total credit-card revenue at the merchant location. Thus, payment processing company A may estimate that the total credit-card revenue for the merchant location was $4,000. However, the data for cash, debit, and check purchases are missing in these determinations.

The systems and methods described herein are directed to using transaction data and geotemporal data to more accurately determine a payment processing company's respective share of merchant revenue (“revenue share”). The systems and methods described herein are further directed to providing a more accurate valuation of the merchant using the transaction data, the geotemporal data, and the determined revenue share. The merchant valuation system includes a payment processing network, which includes or otherwise is in communication with a revenue determination (RD) computing device. The payment processing network communicates transaction data for a particular merchant location to the RD computing device. The merchant valuation system further includes a geotemporal network, which communicates geotemporal data for a geographic region including the merchant location to the RD computing device, either through the payment processing network or independently of the payment processing network. The geotemporal data is extracted from signals emitted from a plurality of mobile devices located within the geographic region. The RD computing device receives and analyzes the transaction data and the geotemporal data to generate a revenue report.

The following detailed description illustrates embodiments of the disclosure by way of example and not by way of limitation. It is contemplated that the embodiments have general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

At least one of the technical problems addressed by this system includes: (i) inaccurate determinations of revenue share generated by cardholders using payments cards associated with a payment processing network; and (ii) inaccurate determinations of total merchant revenue over a period of time.

The system and methods described herein are directed to improving the accuracy of determinations of merchant revenue for a particular merchant or merchant location during a predetermined period of time. In particular, the system described herein uses transaction data of payment card users and geotemporal data for a plurality of mobile devices in order to calculate revenue share and/or total merchant revenue. The technical effect of the disclosure is achieved by: (i) receiving, at the revenue determination computing device, a revenue report request message generated by a requesting party, the revenue report request message including a merchant identifier and a report period, wherein the merchant identifier associates a merchant with a merchant location; (ii) receiving transaction data for the merchant associated with the merchant location from a payment processing network, the transaction data including a plurality of payment card transactions initiated during the report period by cardholders with the merchant, each payment card transaction having an associated transaction amount; (iii) receiving geotemporal data for a geographic region including the merchant location, wherein the geotemporal data is extracted from signals emitted from a plurality of mobile devices located within the geographic region during the report period; (iv) analyzing the geotemporal data to determine a number of visitors located at the merchant location during the report period, wherein a visitor is associated with a mobile device that is located at the merchant location during the report period; (v) calculating a revenue share using the transaction data and the number of visitors, wherein the revenue share represents a share of merchant revenue generated by cardholders having payment cards associated with the payment processing network; and (vi) providing a revenue report to the requesting party, the revenue report including the revenue share.

The technical effect achieved by this system is at least one of: (i) more accurate determinations of revenue share; and (ii) more accurate determinations of total merchant revenue over a period of time.

Generally, consumers may use payment cards to pay for goods and/or services at merchant locations. Cardholders (e.g., a consumer using a payment card such as a credit card, a debit card, or a prepaid card) will initiate payment transactions with merchants at these merchant locations. Transaction data associated with these payment transactions (“transactions”) are received and processed by a payment processor over a payment network. The transaction data include, among other data points, data associated with the cardholder and the merchant involved in the payment transaction. For example, transaction data may include a merchant identifier that can be used by the payment processor to identify or look up the location of the merchant. A revenue determination (RD) computing device receives transaction data for the merchant from the payment processor. As explained below in further detail, the RD computing device is configured to: (i) receive transaction data for a plurality of transactions from the payment processor; (ii) receive geotemporal data from a geotemporal network for a merchant location associated with the merchant using the merchant identifier; (iii) calculate, using the transaction data and geotemporal data, a share of merchant revenue (“revenue share”) generated by cardholder transactions, wherein a cardholder performed a transaction using a credit card associated with the payment processing company; and (iv) calculate total merchant revenue for the merchant.

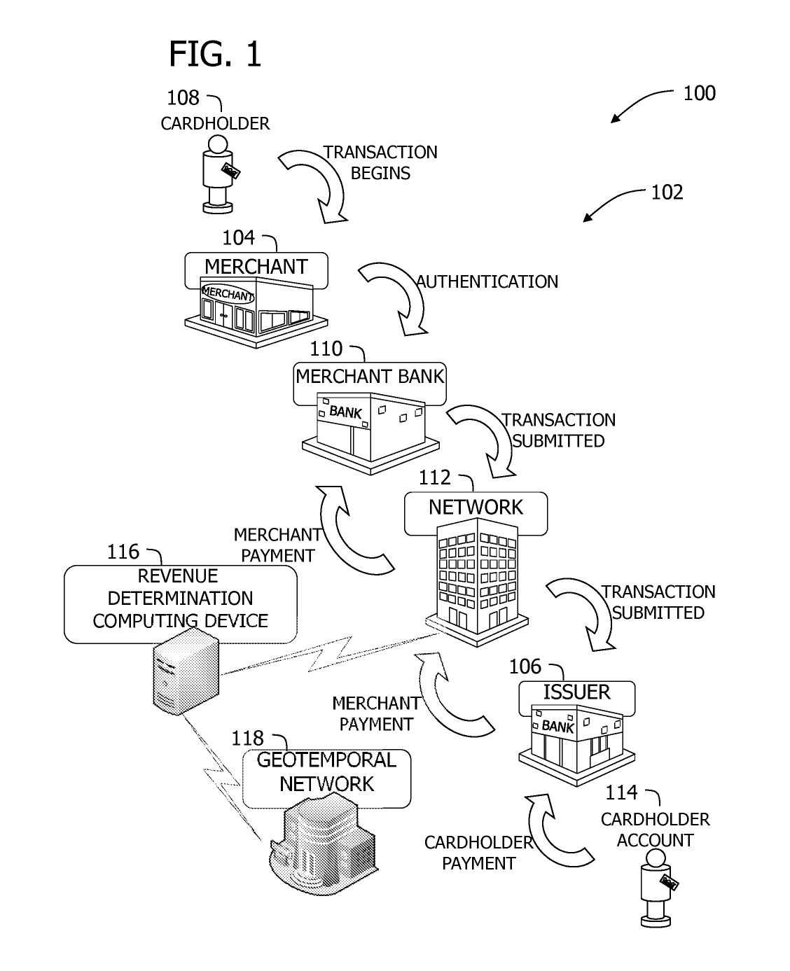

FIG. 1 is a schematic diagram 100 illustrating an example multi-party payment card industry system 102 for using geotemporal data to calculate merchant revenue. The methods and systems described herein relate to a payment card system, such as a credit card payment system using the MasterCard® interchange. The MasterCard® interchange is a proprietary communications standard promulgated by MasterCard International Incorporated® for the exchange of financial transaction data between financial institutions that are customers of MasterCard International Incorporated®. (MasterCard is a registered trademark of MasterCard International Incorporated located in Purchase, N.Y., U.S.A.).

Payment processing system, such as system 102, may utilize a variety of different types of payment cards offered as payment by the consumer. Payment cards can refer to, for example, credit cards, debit cards, and prepaid cards. These cards can all be used as a method of payment for performing a transaction. As described herein, the term “payment card” includes cards such as credit cards, debit cards, and prepaid cards, but also includes any other devices that may hold payment account information, such as mobile phones, personal digital assistants (PDAs), and key fobs.

In the payment card system, a financial institution called the “issuer” 106 issues a payment card, such as a credit card, to a cardholder 108, who uses the payment card to tender payment for a purchase from merchant 104. To accept payment with the payment card, merchant 104 must normally establish an account with a financial institution that is part of the financial payment system. This financial institution is usually called the “merchant bank” 110 or the “acquiring bank” or “acquirer bank.” When cardholder 108 tenders payment for a purchase with the payment card, merchant 104 requests authorization from merchant bank 110 for the amount of the purchase. The request may be performed over telephone, but is usually performed through the use of a point-of-sale (POS) terminal (not shown in FIG. 1). POS terminal reads the payment card identification information from, for example, a magnetic stripe on the payment card or a wireless communication device within the payment card, and communicates electronically with the transaction processing computers of merchant bank 110. Alternatively, merchant bank 110 may authorize a third party (not shown in FIG. 1) to perform transaction processing on its behalf. In this case, a POS terminal of the merchant 104 will be configured to communicate with the third party. Such a third party is usually called a “merchant processor” or an “acquiring processor.”

Using an interchange network 112, the computers of merchant bank 110 or the merchant processor will communicate with the computers of issuer bank 106 to determine whether the cardholder's account is in good standing and whether the purchase is covered by the cardholder's available credit line. Based on these determinations, the request for authorization will be declined or accepted. If the request for authorization is accepted, an authorization code is issued to merchant 104 via an authorization response message.

In the case of a credit card, when a request for authorization is accepted, the available credit line of cardholder's account 114 is decreased. Normally, a charge is not posted immediately to the cardholder's account because bankcard associations have promulgated rules that do not allow merchant 104 to charge, or “capture,” a transaction until goods are shipped or services are delivered. When merchant 104 ships or delivers the goods or services, merchant 104 captures the transaction by, for example, appropriate data entry procedures on a POS terminal. If the cardholder cancels a transaction before it is captured, a “void” is generated. If the cardholder returns goods after the transaction has been captured, a “credit” is generated.

After an electronic payment transaction is captured, the transaction is settled between merchant 104, merchant bank 110, and issuer 106. Settlement refers to the transfer of financial data or funds between a transaction account of merchant 104, merchant bank 110, and issuer 106 related to the transaction. Usually, transactions are captured and accumulated into a “batch,” which are settled as a group.

The system 102 further includes a revenue determination (RD) computing device 116 in communication with interchange network 112. RD computing device 116 is configured to calculate a revenue share and/or a total merchant revenue for a merchant in response to a revenue report request message initiated by a requesting party. RD computing device 116 is further configured to receive transaction data from interchange network 112 for a plurality of transactions performed at a merchant location associated with merchant 104. Each of the plurality of transactions is performed by a cardholder having a payment card associated with interchange network 112 (e.g., a payment processing company). RD computing device 116 is further configured to receive geotemporal data for a geographic region including the merchant location from geotemporal network 118. The geotemporal data is extracted from signals emitted by a plurality of mobile devices located within the geographic region. RD computing device 116 is configured to analyze the received transaction data and geotemporal data in order to calculate a revenue share for the merchant location. The revenue share represents the share (e.g., a fraction or percentage) of total merchant revenue for the merchant generated by the cardholders. RD computing device 116 is further configured to use the calculated revenue share to calculate total merchant revenue. RD computing device 116 is further configured to generate a revenue report including at least one of the revenue share and the total merchant revenue and to provide the revenue report to a requesting party. As used herein, the term “revenue report” refers generally to the deliverable output of the systems and methods described herein. The revenue report includes details of the merchant valuation determined and/or calculated by the RD computing device 116.

As used herein, the term “geolocation” refers to a user's location as collected from a cell phone tower or beacon, global positioning service (GPS), or other position indicators, and can include GPS coordinates, street address, an IP address, geo-stamps on digital photographs, smartphone check-in or other data, and other location data provided as a result, for example, of a telecommunications or online activity of a user. GPS systems receive signals from a plurality of GPS satellites and to determine the location of the GPS sensor and the mobile device using the signals.

“Regions,” “geographic regions,” or “georegions” are geographically defined regions corresponding to groupings of geolocation data, and can refer to cell phone tower broadcast areas, metropolitan areas, counties, states, or other groupings made in accordance with the geolocation data. Geographic regions can be identified as points (e.g., latitude-longitude coordinates) or as areas defined by boundaries.

“Geotemporal” data is combined temporal (i.e., relating to time) and geolocation data (cell phone tower location, IP address, GPS coordinates) that is sent, usually along with other information, from a communications device a user is accessing (such as a cell phone, computer, GPS device, or other mobile device) to perform a certain activity at a particular time. In other words, geotemporal data is extracted from signals emitted by a plurality of mobile devices and includes both a timing aspect and a geolocation aspect. Geotemporal data may enable the location of a mobile device in a particular place at a particular time. The geotemporal network can include, for example, cellular towers, cellular networks, global positioning system (GPS) providers, GPS networks, mobile device networks, client application (e.g., “app”) providers, client application systems, and/or other networks where geotemporal data is collected and/or stored from mobile devices.

As used herein, the terms “reporting party” and “requesting party” refer generally to any institution requesting a revenue report as described herein. The requesting party may be one of the merchant 104, issuer 106, merchant bank 110, and any other entity. For example, the requesting party may be a financial institution that is considering lending to the merchant 104. As another example, the requesting party may be a payment processor. The payment processor may be included in the payment card system 102, which is authorized to collect transaction data without further request. In other embodiments, the requesting party must obtain authorization to collect transaction data or may otherwise obtain transaction data, for example, by purchasing the transaction data from a payment processing company (e.g., a payment processing company including system 102). The term “report receiving party” refers generally to any party or entity receiving (e.g., purchasing) a revenue report from a requesting party. The report receiving party may be the requesting party or may be separate from the requesting party. In some embodiments, the RD computing device of the merchant valuation system described herein may provide a revenue report directly to a requesting party or, alternatively, directly to a report receiving party.

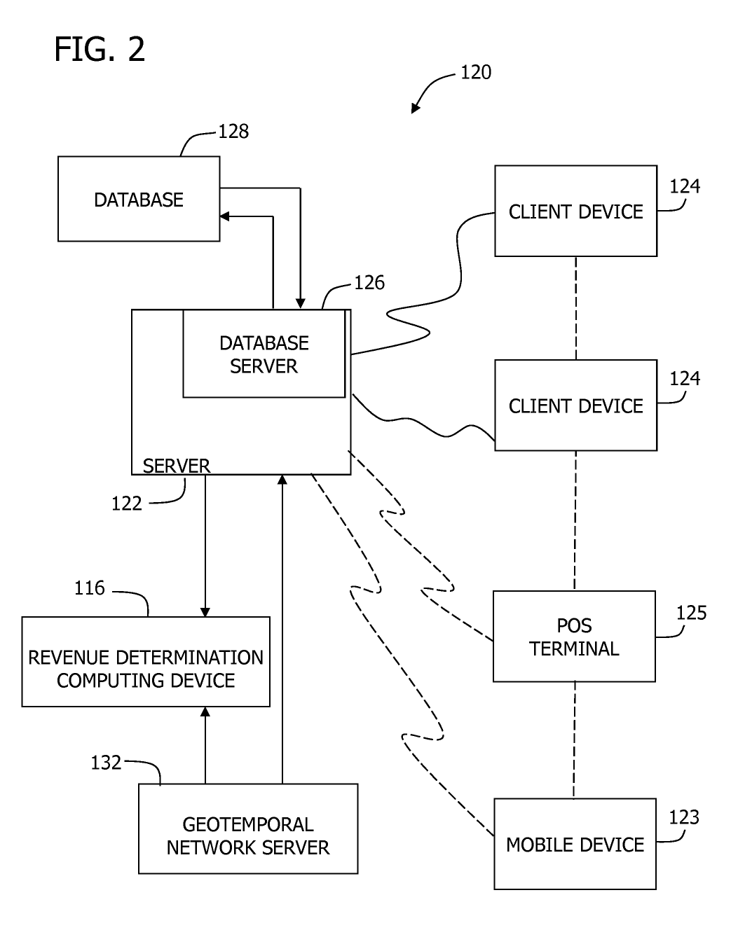

FIG. 2 is a simplified block diagram of an example embodiment of a merchant valuation system 120 for using geotemporal data to calculate merchant revenue. Merchant valuation system 120 is in communication with a payment processing network (e.g., network 112, shown in FIG. 1), which provides transaction data for a merchant (e.g., merchant 104, shown in FIG. 1) to a revenue determination computing device (e.g., revenue determination computing device 116, shown in FIG. 1). Merchant valuation system 120 is further in communication with a geotemporal network (e.g., geotemporal network 118, shown in FIG. 1), which provides geotemporal data for a geographic region including a merchant location of merchant 104 to revenue determination (RD) computing device 116. The geotemporal data is extracted from signals emitted from a plurality of mobile devices 123 located within the geographic region.

More specifically, in the example embodiment, merchant valuation system 120 includes a server system 122, and a plurality of client sub-systems, also referred to as mobiles devices 123 and client devices 124, connected to server system 122. Merchant valuation system 120 further includes RD computing device 116. RD computing device 116 can be in communication with or, alternatively, integral to server system 122. In the example embodiment, mobile devices 123 are any mobile device capable of interconnecting to the Internet including a web-based phone, also referred to as smart phone, personal digital assistant (PDA), tablets, or other web-based connectable equipment. Mobile devices 123 may be associated with a user or consumer, for example cardholder 108. Mobile devices 123 may be interconnected to the Internet through a variety of interfaces including a network, such as a local area network (LAN) or a wide area network (WAN), dial-in connections, cable modems and special high-speed ISDN lines. Mobile devices 123 may be in communication with a geotemporal network (not shown in FIG. 2). As described above, the geotemporal network receives and collects geotemporal data from mobile devices 123 located within a geographic region that includes a merchant location of merchant 104. Although illustrated as including one mobile device 123, merchant valuation system 120 may include any number of mobile devices 123.

Client devices 124 may be computers including a web browser, such server system 122 is accessible to client devices 124 using the Internet. Client devices 124 are interconnected to the Internet through many interfaces, such as a local area network (LAN) or a wide area network (WAN), dial-in-connections, cable modems, special high-speed Integrated Services Digital Network (ISDN) lines, and reliable data transfer (RDT) networks. Client devices 124 may include devices associated with cardholders, such as mobile devices 123. Client devices 124 may include a computer system associated with at least one of an online bank, a bill payment outsourcer, an acquirer bank, an acquirer processor, an issuer bank associated with a transaction card, an issuer processor, a remote payment system, customers and/or billers. Client devices 124 could be any device capable of interconnecting to the Internet including a web-based phone, PDA, personal computer, or other web-based connectable equipment.

Merchant valuation system 120 also includes a point-of-sale (POS) terminal 125, which is connected to mobile devices 123 and client devices 124 and may be connected to server system 122. POS terminal 125 may be associated with merchant 104, and server system 122 may be associated with payment processing network 112. POS terminal 125 may be interconnected to the Internet through a variety of interfaces including a network, such as a local area network (LAN) or a wide area network (WAN), dial-in connections, cable modems, wireless modems, cellular communications, and special high-speed ISDN lines. POS terminal 125 may be any device capable of interconnecting to the Internet and of reading information from a consumer's payment card. Although illustrated as including one POS terminal 125, system 120 may include any number of POS terminals 125 and operate as described herein.

A database server 126 is connected to database 128, which contains information on a variety of matters, as described below in greater detail. In one embodiment, centralized database 128 is stored on server system 122 and can be accessed by potential users at one of mobile devices 124 by logging onto server system 122 through one of mobile devices 124. In an alternative embodiment, database 128 is stored remotely from server system 122 and may be non-centralized. Database 128 may store transaction data generated as part of sales activities conducted over the payment card system 102 including data relating to merchant locations, account holders or consumers, and purchases. In particular, database 128 may store transaction data for a plurality of transactions initiated by cardholders at a merchant location, wherein cardholders initiate the transactions using payment cards associated with payment processing network 112.

RD computing device 116 (which includes any computing device programmed to perform as described herein) is configured to receive transaction data from at least one of database 128, server system 122, and database server 136. RD computing device 116 is further configured to receive geotemporal data from a geotemporal network server 132. Geotemporal network server 132 may be a component in a larger geotemporal network, as described above but not shown in FIG. 2. RD computing device 116 calculates revenue share for a merchant location based on the transaction data and the geotemporal data. RD computing device 116 may also calculate total merchant revenue for the merchant location based at least on the revenue share.

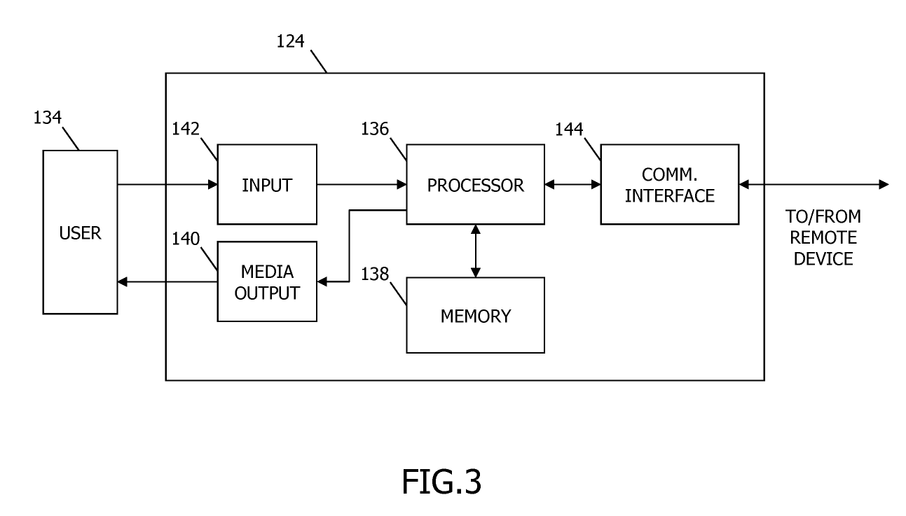

FIG. 3 illustrates an example configuration of a client device 124 operated by a user 134 (e.g., cardholder 108, shown in FIG. 1). Client device 124 may be used to send a revenue report request message to revenue determination computing device 116 (shown in FIG. 1). Client device 124 may be used to receive a revenue report. Client device 124 may include a mobile device 123 operated by a consumer. Client device 124 may include, but is not limited to, POS terminal 125 and a device associated with any one of merchant 104, issuer 106, and merchant bank 110 (shown in FIG. 1). Client device 124 includes a processor 136 for executing instructions. In some embodiments, executable instructions are stored in a memory area 138. Processor 136 may include one or more processing units (e.g., in a multi-core configuration). Memory area 138 is any device allowing information such as executable instructions and/or written works to be stored and retrieved. Memory area 138 may include one or more computer readable media.

Client device 124 also includes at least one media output component 140 for presenting information to user 134. Media output component 140 is any component capable of conveying information to user 134. In some embodiments, media output component 140 includes an output adapter such as a video adapter and/or an audio adapter. An output adapter is operatively coupled to processor 136 and operatively couplable to an output device such as a display device (e.g., a liquid crystal display (LCD), organic light emitting diode (OLED) display, or “electronic ink” display) or an audio output device (e.g., a speaker or headphones).

In some embodiments, client device 124 includes an input device 142 for receiving input from user 134. Input device 142 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 140 and input device 142.

Client device 124 may also include a communication interface 144, which is communicatively couplable to a remote device such as server system 122 (shown in FIG. 2). Communication interface 144 may include, for example, a wired or wireless network adapter or a wireless data transceiver for use with a mobile phone network (e.g., Global System for Mobile communications (GSM), 3G) or other mobile data network (e.g., Worldwide Interoperability for Microwave Access (WIMAX)).

Client device 124 may be a mobile device 123 operated by a consumer. Client device 124 may also include a global positioning system (GPS) sensor integral with communication interface 144, input device 142, or as a separate component. The GPS sensor is configured to receive signals from a plurality of GPS satellites and to determine the location of the GPS sensor and the client device using the signals. More specifically, the GPS sensor determines geolocation information for client device 124. The geolocation information may be calculated, for example, by communicating with satellites using communication interface 144. The GPS sensor determines the location of the client device.

Stored in memory area 138 are, for example, computer readable instructions for providing a user interface to user 134 via media output component 140 and, optionally, receiving and processing input from input device 142. A user interface may include, among other possibilities, a web browser and client application. Web browsers enable users, such as user 134, to display and interact with media and other information typically embedded on a web page or a website from server system 122. A client application allows user 134 to interact with a server application from server system 122.

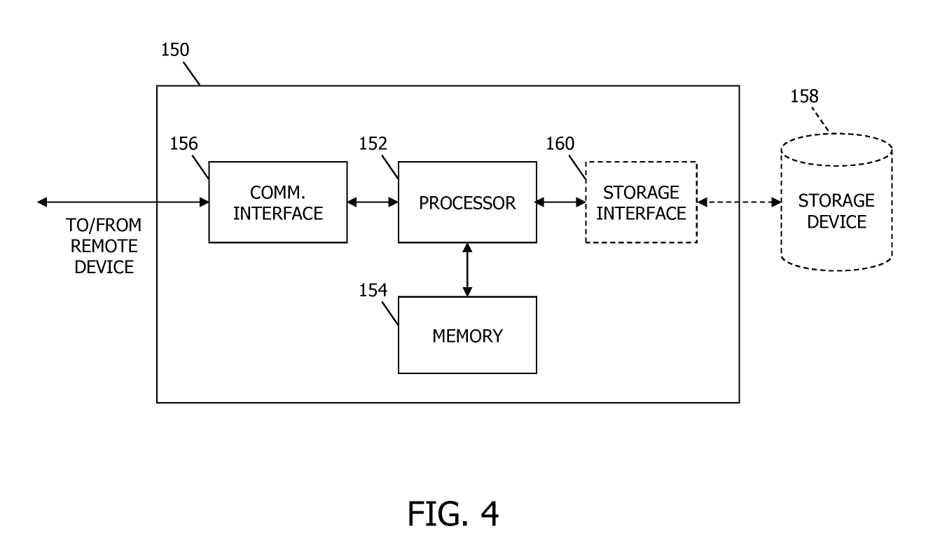

FIG. 4 illustrates an example configuration of a server computing device 150. Server computing device 150 may include, but is not limited to, revenue determination computing device 116, database server 126, geotemporal network server 132, interchange network 112, or any other computing device configured to function as described herein.

Server computing device 150 includes a processor 152 for executing instructions. Instructions may be stored in a memory area 154, for example. Processor 152 may include one or more processing units (e.g., in a multicore configuration).

Processor 152 is operatively coupled to a communication interface 156 such that server computing device 150 is capable of communicating with a remote device such as client device 124 (shown in FIG. 3) or another server computing device 150. For example, communication interface 156 may receive requests from a client device 124 via the Internet.

Processor 152 may also be operatively coupled to storage device 158. Storage device 158 is any computer-operated hardware suitable for storing and/or retrieving data. In some embodiments, storage device 158 is integrated in server computing device 150. For example, server computing device 150 may include one or more hard disk drives as storage device 158. In other embodiments, storage device 158 is external to server computing device 150 and may be accessed by a plurality of server computing devices 150. For example, storage device 158 may include multiple storage units such as hard disks or solid state disks in a redundant array of inexpensive disks (RAID) configuration. Storage device 158 may include a storage area network (SAN) and/or a network attached storage (NAS) system.

In some embodiments, processor 152 is operatively coupled to storage device 158 via a storage interface 160. Storage interface 160 is any component capable of providing processor 152 with access to storage device 158. Storage interface 160 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 152 with access to storage device 158.

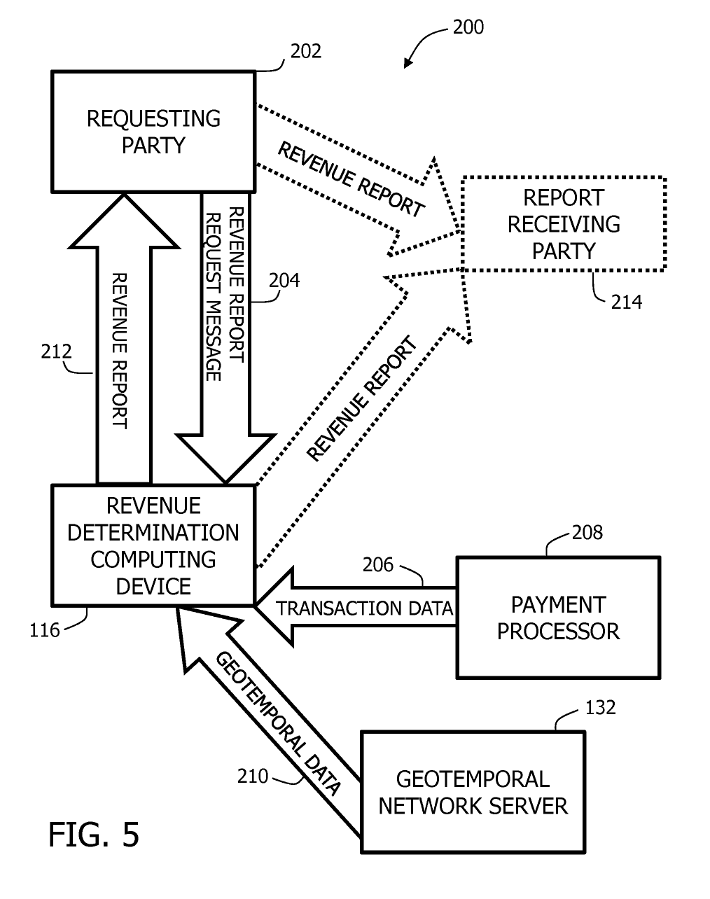

FIG. 5 is a data flow diagram showing the flow of data between the revenue determination (RD) computing device 116 (shown in FIG. 1), the payment processor 208, and the geotemporal network server 132 within an example merchant valuation system (e.g., merchant valuation system 120, shown in FIG. 2). Merchant valuation system 120, as described herein, enables a requesting party 202 to submit a revenue report request message 204 including a merchant identifier and a report period to RD computing device 116. The term “report period” as is used to refer generally to a predetermined period of time antedating the revenue report request message. For example, the report period may be one month, six months, one year, or any other period of time prior to the date of the submission of the revenue report request message. RD computing device 116 receives transaction data 206 for the merchant location and the report period from a payment processor 208, which can be included in a payment card processing system (e.g., system 102).

RD computing device 116 receives geotemporal data 210 for the report period from a geotemporal network server 132 based on the information contained within the revenue report request message 204. The geotemporal data 210 is received for a plurality of mobile devices in a geographic region including the merchant location identified using the merchant identifier in the revenue report request message 204. RD computing device 116 analyzes the geotemporal data to determine a number of visitors at the merchant location. As used herein, “visitor refers generally to a consumer that is located at the merchant location during the report period. Generally, RD computing device 116 determines the number of visitors by using the geotemporal data to identify each mobile device shown to be located at the merchant location during the report period as a visitor. RD computing device 116 uses the transaction data 206 and the number of visitors to calculate a revenue share for the merchant, wherein the revenue share represents a share of merchant revenue generated by cardholders having payment cards associated with the payment processing system. RD computing device 116 then provides a revenue report 212 to the reporting party 202 or, alternatively, to a report receiving party 214.

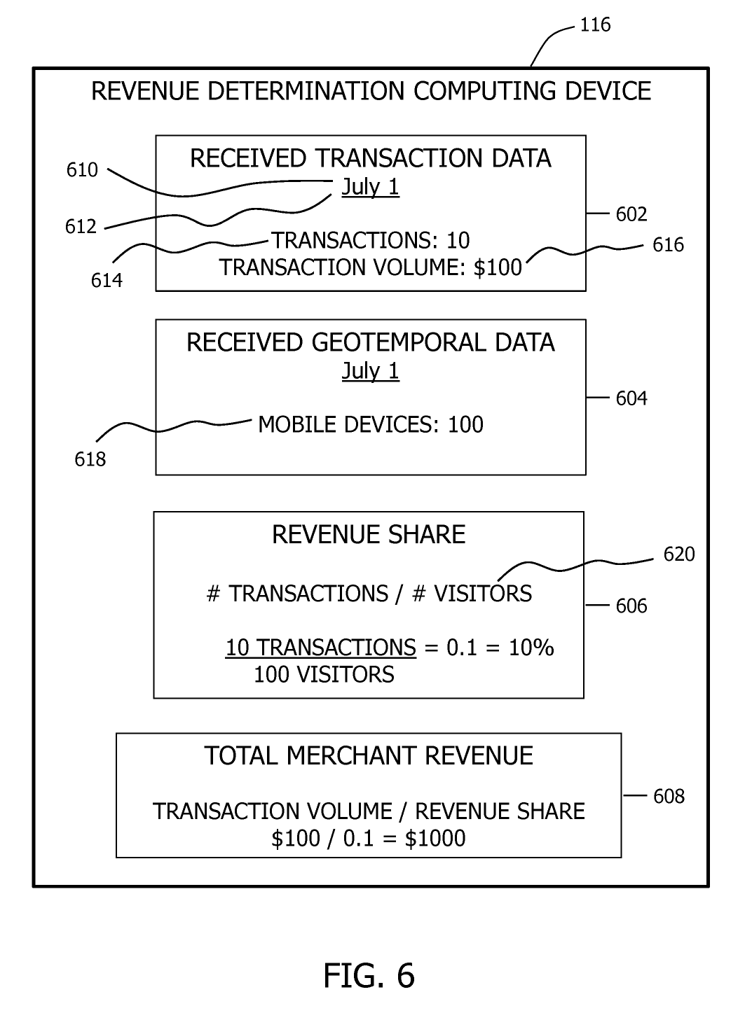

FIG. 6 illustrates an example revenue determination (RD) computing device 116 (shown in FIG. 1). RD computing device 116 receives transaction data 602 from a payment processing network (e.g., network 112, shown in FIG. 1). Transaction data 602 represents data for a plurality of transactions initiated by cardholders at a merchant location over a report period 610. Cardholders initiate transactions using payment cards associated with payment processing network 112. In the example embodiment, transaction data 602 includes a transaction date 612, a number of the plurality of transactions 614, and a transaction volume 616, which represents the total amount of money spent at the merchant by the cardholders over the report period 610. Transaction data 602 may also include a merchant identifier (not shown), to identify the merchant location (e.g., a physical address) associated with the merchant. In the example embodiment, the transaction date 612 is equal to the report period 610, as the report period 610 is one day, July 1 (in this example). In other embodiments, if the report period 610 covers multiple days, the transaction date 612 may still be one particular date and/or time within the report period 610. In the example embodiment, the number of transactions 614 is 10, and the transaction volume 616 is $100.

RD computing device 116 also receives geotemporal data 604 for a geographic region that includes the merchant location from a geotemporal network (e.g., network 118, shown in FIG. 1). The geotemporal data 604 is extracted from signals emitted by a plurality of mobile devices located within the geographic region during the report period 610. The “100 mobile devices” illustrated in the example embodiment is a subset of the plurality of mobile devices 618, wherein the subset of mobile devices 618 includes each of the plurality of mobile devices located at the merchant location during the report period 610. The number of mobile devices 618 may also be called the number of visitors 620 of the merchant location, by assuming that each mobile device determined to be located at the merchant location during the report period is associated with a user that is a visitor.

RD computing device 116 calculates a revenue share 606 for the merchant location associated with the payment processing network 112. In other words, RD computing device 116 calculates a fraction of percentage of merchant revenue generated over the report period 610 by cardholders using payment cards associated with the payment processing network 112. In the example embodiment, revenue share 606 is calculated by dividing the number of transactions 614 by the number of visitors 620. This determination method assumes that each visitor made a purchase. Therefore, by inferring the number of visitors that are cardholders (using the number of transactions 614 made by cardholders), RD computing device 116 determines that 10% of visitors are cardholders. By further assuming that an average cardholder transaction amount (not shown) is equal to an average visitor transaction amount (i.e., that an average cardholder of payment processing network 112 spends as much as an average consumer), RD computing device 116 determines that 10% of total merchant revenue is the revenue share 606 generated by cardholders using payment cards associated with the payment processing network 112. In other words, the revenue share 606 of payment processing network 112 at the merchant location is 0.1 or 10%.

In the example embodiment, RD computing device 116 further calculates total merchant revenue 608 using the calculated revenue share 606 and the transaction volume 616. In particular, RD computing device 116 divides the transaction volume 616 by the revenue share 606 (as a fraction). This determination method also assumes that an average cardholder transaction amount is equal to an average visitor transaction amount. Therefore, the (cardholder) transaction volume 616 of the number of (cardholder) transactions 614 is representative of a (non-cardholder) visitor volume of the same number of (non-cardholder) visitor transactions. In other words, RD computing device 116 determines that the 10% revenue share 606 represents 10% of the total merchant revenue 608. In the example embodiment, RD computing device 116 calculates that total merchant revenue 608 for the merchant at the merchant location for July 1 is $1000.

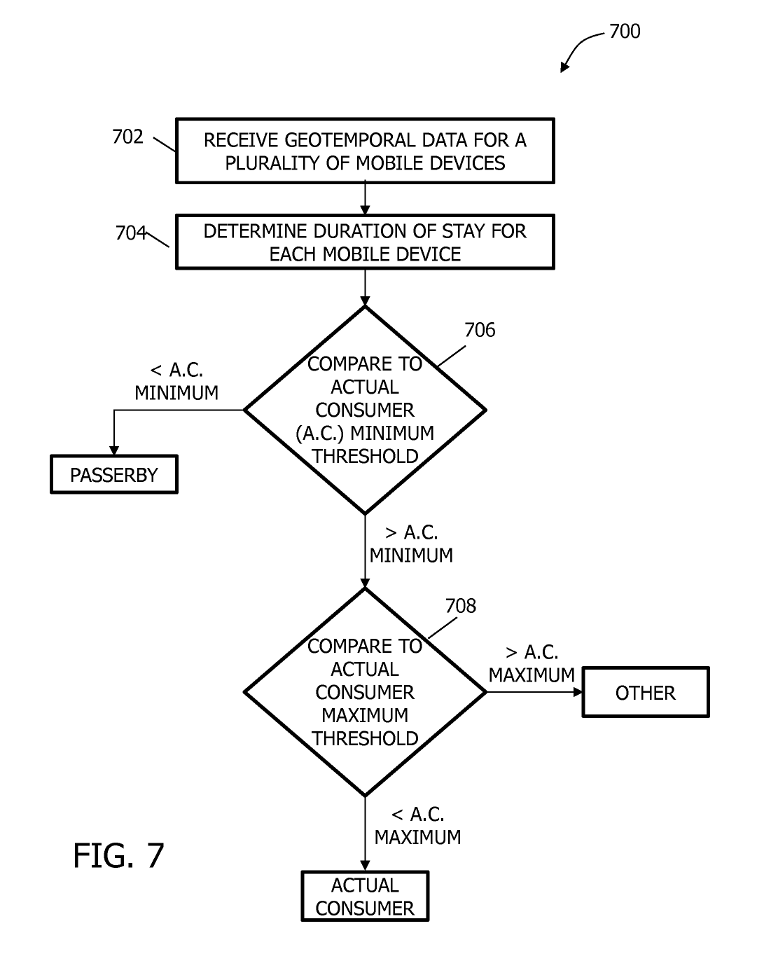

FIG. 7 is a flow diagram illustrating an example method 400 for categorizing visitors based on received geotemporal data. RD computing device 116 is configured to analyze received geotemporal data to determine a number of visitors at the merchant location. In some embodiments, RD computing device 116 may perform this analysis by determining a duration of stay at the merchant location for each of a subset of the plurality of mobile devices. In the example embodiment, each of the subset of the mobile devices is associated with a user that is a “visitor” to the merchant location (i.e., is located at the merchant location at some point during the report period).

Method 700 includes receiving 702, by RD computing device 116, the geotemporal data for the subset of mobile devices (associated with respective visitors). RD computing device 116 further determines 704 a duration of stay for each mobile device (associated with a respective visitor). For example, RD computing device 116 may be configured to identify a first location for each of the subset of mobile devices based on the received geotemporal data. RD computing device 116 may further be configured to compare the first location for each of the subset of mobile devices to a second location for each of the subset of mobile devices, wherein the second location is a location of a mobile device at a subsequent point in time. RC computing device 116 may continue to compare subsequent (e.g., third, fourth, etc.) locations of each mobile device to determine how long each mobile device remained at the merchant location.

In the example embodiment, RD computing device 116 compares 706 the duration of stay for each mobile device to an actual consumer minimum threshold value (e.g., a minimum threshold of time assumed to indicate that a visitor stayed long enough to make a purchase). An “actual consumer” is used to refer generally to a consumer or visitor that is assumed to initiate a transaction (e.g., actually make a purchase) at the merchant location based on the duration of stay at the merchant location. Generally, an actual consumer is defined by a duration of stay at the merchant location greater than a threshold period of time, as described below in more detail. If the duration of stay of the mobile device is less than the actual consumer minimum threshold, the associated visitor is not categorized as an actual consumer but is categorized differently, e.g., as passerby. If the duration of stay of the mobile device is greater than an actual consumer minimum threshold, RD computing device 116 compares 708 the duration of stay of the mobile device to an actual consumer maximum threshold value. If the duration of stay of the mobile device is greater than the actual consumer maximum threshold, the associated visitor is categorized differently, e.g., as other or employee. If the duration of stay of the mobile device is less than the actual consumer maximum threshold, the associated visitor is categorized as an actual consumer. RD computing device 116 may therefore determine a count of the number of actual consumers for a merchant location and/or a count of the numbers of passersby.

The actual consumer maximum threshold may be selected based on the merchant location and/or merchant industry and may be several minutes to several hours. The actual consumer minimum threshold may be selected based on the merchant location and may be several minutes (less than the actual consumer maximum threshold). For example, for a coffee shop, the actual consumer minimum and maximum thresholds may be three minutes and two hours, respectively. For a grocery store, the actual consumer minimum and maximum thresholds may be ten minutes and three hours, respectively. The preceding examples are meant as examples only and are not intended to be limiting in any way, as the actual consumer maximum and minimum thresholds may be any period of time.

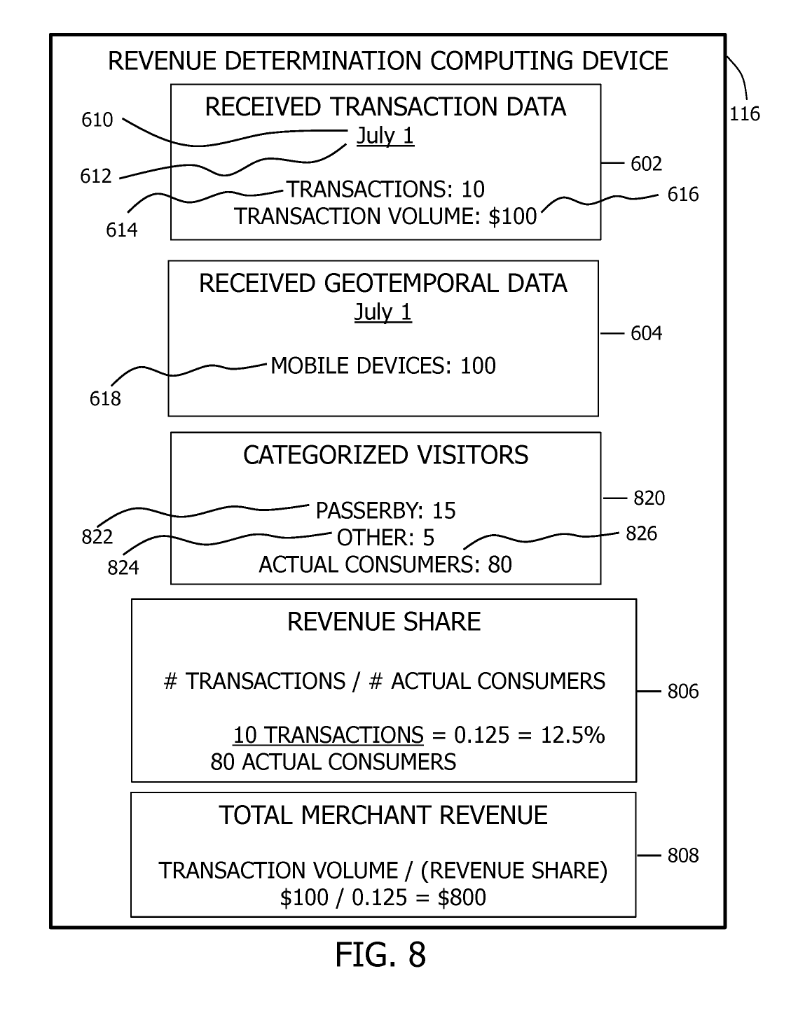

FIG. 8 illustrates an example revenue determination (RD) computing device (e.g., RD computing device 116, shown in FIG. 6). As described with respect to FIG. 6, in the example embodiment, RD computing device 116 receives transaction data 602 for a plurality of transactions 614 from payment processing network 112 (shown in FIG. 1). RD computing device 116 also receives geotemporal data 604 for a geographic region from a geotemporal network 118 (shown in FIG. 1), wherein the geotemporal data is extracted from signals emitted by a plurality of mobile devices located within the geographic region. Geotemporal data 604 includes information (not shown) regarding a duration of stay of each of a subset of mobile devices 618 at the merchant location.

RD computing device 116 analyzes the received geotemporal data to determine a number of visitors. The analysis may include categorizing visitors associated with respective mobile devices, as described with respect to FIG. 7. RD computing device 116 determines that, of the categorized visitors 820, fifteen mobile devices are associated with visitors categorized as passerby 822, five mobile devices are associated with visitors categorized as others 824, and 80 mobile devices are associated with visitors categorized as actual consumers 826. In the example embodiment, RD computing device 116 uses the same inferences and assumptions as described with respect to FIG. 6, with the exception that RD computing device 116 assumes that an average cardholder transaction amount (not shown) is equal to an average actual consumer transaction amount (i.e., that an average cardholder of payment processing network 112 spends as much as an average actual consumer). RD computing device 116 also assumes that the (cardholder) transaction volume 616 of the number of (cardholder) transactions 614 is representative of a (non-cardholder) actual consumer volume of the same number of (non-cardholder) actual consumer transactions. RD computing device 116 therefore calculates a revenue share 806, for the merchant at the merchant location, associated with the payment processing network 112 of 12.5%. RD computing device 116, in the example embodiment, further calculates a total merchant revenue 808 for the report period 610, July 1, of $800.

As an additional feature of the systems and methods described herein, in some embodiments (not shown in FIG. 8), RD computing device 116 may further be configured to generate a “geotemporal fingerprint” for each mobile device, in order to identify a particular mobile device associated with a particular cardholder. A geotemporal fingerprint can be generated based on a compilation of geolocation information and timestamps that track a mobile device's location and activities of a user associated with the mobile device, as described in co-owned application Ser. No. 13/671,791, entitled “Methods For Geotemporal Fingerprinting,” by Howe (which is incorporated herein by reference in its entirety). A geotemporal fingerprint can be generated for mobile devices from “ping” data, which includes geotemporal data. A device ID is preferably associated with each mobile device and associated with the geotemporal fingerprint for distinguishing the mobile device from others in a mobile device database (e.g., a cell phone database). Once a primary (e.g., home) and a secondary (e.g., work place or school) region associated with each device ID are identified, other identifying criteria can be defined and ascertained from the ping data and recorded to generate a geotemporal fingerprint for each mobile device.

Alternatively, a geotemporal fingerprint for a cardholder or a social media user can be generated from other databases related to other types of consumer activity, such as one of various types of on-line social networking databases or payment card usage. In these embodiments, a geotemporal fingerprint is similarly formed from the geotemporal data, which can include beacon or cell tower IDs or addresses, IP addresses (for example, from a merchant location when a payment card is used, or from a computer/smart phone utilized by a consumer accessing social networking databases), or GPS coordinates, for example. This data will also contain a device/account/profile ID, a geolocation, and a date and time of day, and may also include a period of time associated with the use of the mobile device at the geolocation (for example, a time span over which the associated user is logged on to an activity and active).

Geotemporal fingerprints for mobile devices can be compared to geotemporal fingerprints generated from payment card usage to match a cardholder account with a mobile device using, for example, transaction data associated with the cardholder's payment card. Records of on-line purchases initiated using the payment card can also be collected with geotemporal (including IP address) data.

RD computing device 116 may be further configured to infer relationships between mobile device based on geotemporal data. In some embodiments, a “familial” relationship can be inferred based if two mobile devices are located at the same address which is neither a business nor a multi-family dwelling. The clustering of multiple co-located data points (e.g., mobile devices located at the same geolocation throughout the night) is known in the art of GIS software. Inference of these relationships enables the characterization of multiple “familial” mobile devices—or their device/account/profile IDs—as one associated consumer, using the generated geotemporal fingerprints associated with the familial mobile devices.

Additionally, the inference of relationships may be used in the comparison of transaction data to geotemporal data, for example, to divide or further average transactions that can be attributed to families or couples (i.e., multiple consumers). RD computing device 116 may use the geotemporal fingerprints to adjust at least on the number of visitors and/or actual consumers at the merchant location and the number of transactions at the merchant location. For example, RD computing device 116 may determine that two mobile devices are associated with a brother and a sister. RD computing device 116 may use the geotemporal fingerprints associated with the two mobile devices and determine a particular transaction performed by one of the brother and the sister. RD computing device 116 may “count” that one transaction as two transactions during its determination of revenue share, as RD computing device 116 may “count” the brother and sister each as one visitor or actual consumer. Using the numbers and description of the example embodiment of FIG. 8, RD computing device 116 may adjust its count of actual consumers to be 81 and may adjust its count of transactions to 11. Therefore, the adjusted revenue share may by 0.136 or 13.6%, and the adjusted merchant revenue may be $100/0.136 or $735.

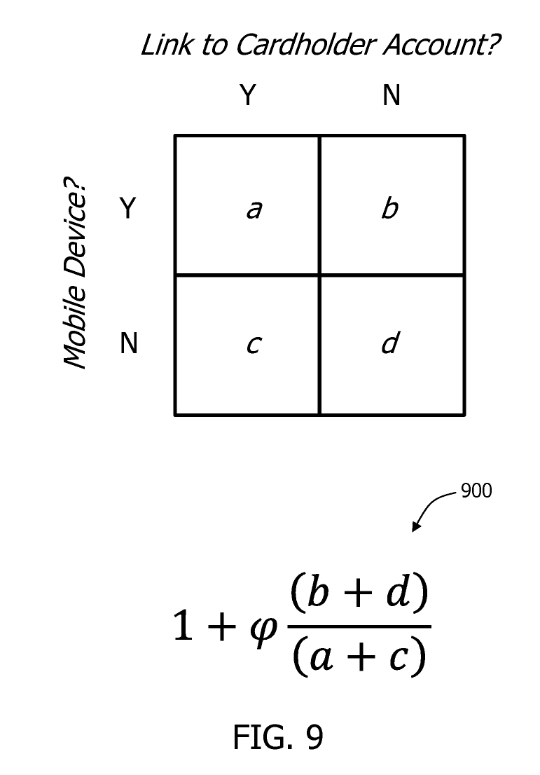

FIG. 9 shows an example grouping of the population for an example scaling factor 900. In some embodiments, the geotemporal data received by the RD computing device 116 (shown in FIG. 1) is extracted from signals emitted by a plurality of mobile devices located within a geographic region including the merchant location, wherein the plurality of mobile devices is not representative of a total population of the geographic region. For example, it may be assumed that each mobile device represents, in a 1:1 ratio, a consumer in the geographic region. However, in this example, RD computing device 116 may only receive geotemporal data representative of 25% of the population. In other words, RD computing device 116 may receive geotemporal data representative of a plurality of mobile devices, wherein the plurality of mobile does not include all mobile devices in the geographic region. As another example, RD computing device 116 may assume that mobile devices do not represents citizens in a 1:1 ratio, but rather in a 1:2 ratio (of mobile devices to citizens) or any other ratio. In other words, RD computing device 116 may not assume that the entire population has a mobile device. In these embodiments, RD computing device 116 must apply a scaling factor (for example, scaling factor 500) to the results of its calculation of revenue share and/or total merchant revenue.

In scaling factor 900, a represents a number of cardholders located within the geographic region, cardholders having payment cards associated with payment processing network 112 (shown in FIG. 1), that also have a mobile device on a given telecommunication network. “Telecommunication network” refers generally herein to a telecommunications network associated with a specific wireless carrier, e.g., Verizon Wireless®, AT&T®, or Sprint® (Verizon Wireless is a registered trademark of Verizon Trademark Services LLC located in Arlington, Va.; AT&T is a registered trademark of AT&T Intellectual Property, Inc. located in Reno, Nev.; Sprint is a registered trademark of Sprint Communications Company L.P. located in Overland Park, Kans.) Further, c represents a number of cardholders located within the geographic region that do not have a mobile device on the given telecommunication network. Generally, (a+c) represents the (total) number of payment cards (and of associated cardholders) associated with payment processing network 112 in the geographic region. The value for (a+c) can be determined, for example, using the credit-reporting information described above.

In scaling factor 900, b represents a number of consumers (i.e., non-cardholders and cardholders using a different payment processing network) located within the geographic region that also have a mobile device on the given telecommunication network. Further, d represents a number of consumers located within the geographic region that do not have a mobile device or that have a mobile device on a different telecommunication network. Generally, (b+d) represents the (total) population with (a+c) subtracted.

In scaling factor 900, φ represents an estimate of the likelihood of a visitor being an actual consumer. A value for φ can be estimated based on the fraction or percentage of the mobile devices associated with visitors that were categorized as actual consumers, as described above with respect to FIG. 7. Using the example described with respect to FIG. 8, RD computing device 116 determined that 80 out of 100 visitors were actual consumers. In this example, φ has a value of 0.8.

Using the scaling factor 900:

1+φ(b+d)/(a+c),

with a population of 1,000,000 and a cardholder count (determined from the credit-reporting information) of 250,000, RD computing device 116 calculates a value of 3.4.

RD computing device 116 may then apply that scaling factor to the calculated total merchant revenue to calculate a scaled merchant revenue. For example, if RD computing device 116 initially calculated a total merchant revenue of $1000, the scaled merchant revenue would be $3400.

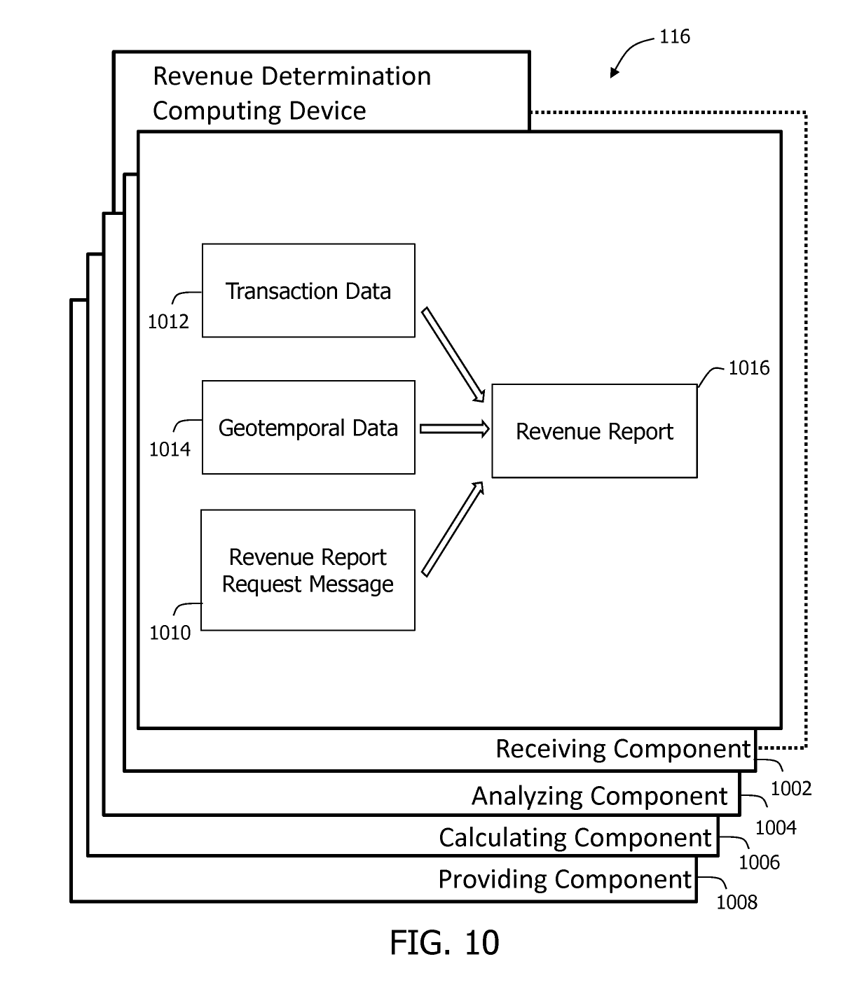

FIG. 10 shows a component view of an example revenue determination (RD) computing device 116, as shown in FIG. 1. RD computing device 116 includes a receiving component 1002 configured to receive a revenue report request message 1010 from a reporting party (e.g., reporting party 202, shown in FIG. 5) the revenue report request message 1010 including a merchant identifier and a report period, wherein the merchant identifier associates a merchant with a merchant location. Receiving component 1002 is also configured to receive transaction data 1012 from a payment processing network (e.g., network 112, shown in FIG. 1). The transaction data 1012 includes a plurality of payment card transactions initiated during the report period by cardholders with the merchant, each payment card transaction having an associated transaction amount. Receiving component 1002 is further configured to geotemporal data 1014 from a geotemporal network (e.g., network 118, shown in FIG. 1). The geotemporal data 1014 is extracted from signals emitted from a plurality of mobile devices located within the geographic region during the report period.

RD computing device 116 also includes an analyzing component 1004 configured to analyze the received geotemporal data to determine a number of visitors located at the merchant location during the report period. Analyzing component 1004 may be configured to implement the processing steps of method 700, as described above with respect to FIG. 7.

RD computing device 116 further includes a calculating component 1006 configured to calculate a revenue share using the transaction data 1012 and the number of visitors, wherein the revenue share represents a share of merchant revenue generated by cardholders having payment cards associated with the payment processing network. RD computing device 116 also includes a providing component 1008 configured to provide a revenue report 1016 to a requesting party (e.g., requesting party 214, shown in FIG. 5).

The systems and methods described herein for determining merchant revenue based on transaction data and geotemporal data offer increased accuracy over previous methods, as they may include all of the data that was missing in traditional methods of revenue share determination—debit card, cash, and check purchases. The information product that can be provided about a particular merchant location, or perhaps about a particular neighborhood or region of merchants, is thus more useful and more desirable to those businesses—e.g., lenders, financial institutions, payment processing companies, commercial real estate companies, etc.—that use these data to make business decisions.

This written description uses examples to disclose various embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for determining merchant revenue using transaction data and geotemporal data, the method implemented using a revenue determination computing device, the method comprising:
receiving, at the revenue determination computing device, a revenue report request message generated by a requesting party, the revenue report request message including a merchant identifier and a report period, wherein the merchant identifier associates a merchant with a merchant location;
receiving transaction data for the merchant associated with the merchant location from a payment processing network, the transaction data including a plurality of payment card transactions initiated during the report period by cardholders with the merchant, each payment card transaction having an associated transaction amount;
receiving geotemporal data for a geographic region including the merchant location, wherein the geotemporal data is extracted from signals emitted from a plurality of mobile devices located within the geographic region during the report period;
analyzing the geotemporal data to determine a number of visitors located at the merchant location during the report period, wherein a visitor is associated with a mobile device that is located at the merchant location during the report period;
calculating a revenue share using the transaction data and the number of visitors, wherein the revenue share represents a share of merchant revenue generated by cardholders having payment cards associated with the payment processing network; and
providing a revenue report to the requesting party, the revenue report including the revenue share.

2. The computer-implemented method of claim 1, wherein calculating the revenue share comprises dividing a number of the plurality of payment card transactions by the number of visitors.

3. The computer-implemented method of claim 1, further comprising calculating total merchant revenue for the merchant associated with the merchant location over the report period, based, at least in part, on the calculated revenue share and a transaction volume, wherein the transaction volume comprises the sum of each transaction amount, and wherein the revenue report further includes the total merchant revenue.

4. The computer-implemented method of claim 3, wherein calculating the total merchant revenue further comprises:
receiving a number of payment cards associated with the payment processing network located within the geographic region;
receiving a population of the geographic region;
determining a likelihood that a mobile device located at the merchant location during the report period is associated with a purchase made at the merchant location; and
applying a scaling factor to the total merchant revenue to calculate a scaled merchant revenue, the scaling factor calculated using an algorithm:
$$1 + ϕ \frac{( b + d )}{( a + c )} ,$$
wherein (a+c) is the number of payment cards, (b+d) is the population minus the number of payment cards, and φ is the likelihood that a mobile device located within the merchant location during the report period is associated with a purchase made at the merchant location.

5. The computer-implemented method of claim 1, wherein analyzing the geotemporal data to determine a number of visitors comprises:
determining, based on the geotemporal data, a duration of stay at the merchant location of each of a subset of mobile devices, wherein the subset of mobile devices includes each of the plurality of mobile devices located at the merchant location during the report period;
categorizing a visitor associated with each of the subset of mobile devices as one of actual consumer, passerby, and other based on the respective duration of stay, wherein an actual consumer is defined by a duration of stay above a minimum actual consumer threshold and below a maximum actual consumer threshold, and wherein a passerby is defined by a duration of stay below the minimum actual consumer threshold; and
calculating the revenue share by dividing a number of the plurality of payment card transactions by a number of actual consumers.

6. The computer-implemented method of claim 1, wherein calculating the revenue share comprises:
comparing the transaction data and the geotemporal data for each visitor;
generating a geotemporal fingerprint for one or more of the visitors based on the comparing, the geotemporal fingerprint identifying a payment account associated with each of the one or more visitors;
using the geotemporal fingerprints to adjust at least one of:
the number of visitors at the merchant location during the report period, and
a number of the plurality of payment transactions; and
calculating an adjusted revenue share by dividing the number of the plurality of payment card transactions by the number of visitors.

7. A merchant valuation computer system for determining merchant revenue using transaction data and geotemporal data, the computer system comprising:
a memory; and
a revenue determination computing device including a processor configured to:
receive a revenue report request message generated by a requesting party, the revenue report request message including a merchant identifier and a report period, wherein the merchant identifier associates a merchant with a merchant location;
receive the transaction data for the merchant associated with the merchant location from a payment processing network, the transaction data including a plurality of payment card transactions initiated during the report period by cardholders with the merchant, each payment card transaction having an associated transaction amount;
receive the geotemporal data for a geographic region including the merchant location, wherein the geotemporal data is extracted from signals emitted from a plurality of mobile devices located within the geographic region during the report period;
analyze the geotemporal data to determine a number of visitors located at the merchant location during the report period, wherein a visitor is associated with a mobile device that is located at the merchant location during the report period;
calculate a revenue share using the transaction data and the number of visitors, wherein the revenue share represents a share of merchant revenue generated by cardholders having payment cards associated with the payment processing network; and
provide a revenue report to the requesting party, the revenue report including the revenue share.

8. The merchant valuation computer system of claim 7, wherein the processor is configured to calculate the revenue share by dividing a number of the plurality of payment card transactions by the number of visitors.

9. The merchant valuation computer system of claim 7, wherein the processor is further configured to calculate total merchant revenue for the merchant associated with the merchant location over the report period, based, at least in part, on the calculated revenue share and a transaction volume, wherein the transaction volume comprises the sum of each transaction amount, and wherein the revenue report further includes the total merchant revenue.

10. The merchant valuation computer system of claim 9, wherein the processor is further configured to:
receive a number of payment cards associated with the payment processing network located within the geographic region;
receive a population of the geographic region;
determine a likelihood that a mobile device located within the merchant location during the report period is associated with a purchase made at the merchant location; and
apply a scaling factor to the total merchant revenue to calculate a scaled merchant revenue, the scaling factor calculated using an algorithm:
$$1 + ϕ \frac{( b + d )}{( a + c )} ,$$
wherein (a+c) is the number of payment cards, (b+d) is the population minus the number of payment cards, and φ is the likelihood that a mobile device located within the merchant location during the report period is associated with a purchase made at the merchant location.

11. The merchant valuation computer system of claim 7, wherein the processor is further configured to:
determine, based on the geotemporal data, a duration of stay at the merchant location of each of a subset of mobile devices, wherein the subset of mobile devices includes each of the plurality of mobile devices located at the merchant location during the report period;
categorize a visitor associated with each of the plurality of mobile devices as one of actual consumer, passerby, and other based on the respective duration of stay, wherein an actual consumer is defined by a duration of stay above a minimum actual consumer threshold and below a maximum actual consumer threshold, and wherein a passerby is defined by a duration of stay below the minimum actual consumer threshold; and
calculate the revenue share by dividing a number of the plurality of payment card transactions by a number of actual consumers.

12. The merchant valuation computer system of claim 7, wherein the processor is further configured to:
compare the transaction data and the geotemporal data for each visitor;
generate a geotemporal fingerprint for one or more of the visitors based on the comparing, the geotemporal fingerprint identifying a payment account associated with each of the one or more visitors;
use the geotemporal fingerprints to adjust at least one of:
the number of visitors at the merchant location during the report period, and
a number of the plurality of payment transactions; and
calculate an adjusted revenue share by dividing the number of the plurality of payment card transactions by the number of visitors.

13. Computer-readable media having computer-executable instructions embodied thereon for determining merchant revenue using transaction data and geotemporal data, wherein when executed by at least one processor, the computer-executable instructions cause the processor to:
receive a revenue report request message generated by a requesting party, the revenue report request message including a merchant identifier and a report period, wherein the merchant identifier associates a merchant with a merchant location;
receive the transaction data for the merchant associated with the merchant location from a payment processing network, the transaction data including a plurality of payment card transactions initiated during the report period by cardholders with the merchant, each payment card transaction having an associated transaction amount;
receive the geotemporal data for a geographic region including the merchant location, wherein the geotemporal data is extracted from signals emitted from a plurality of mobile devices located within the geographic region during the report period;
analyze the geotemporal data to determine a number of visitors located at the merchant location during the report period, wherein a visitor is associated with a mobile device that is located at the merchant location during the report period;
calculate a revenue share using the transaction data and the number of visitors, wherein the revenue share represents a share of merchant revenue generated by cardholders having payment cards associated with the payment processing network; and
provide a revenue report to the requesting party, the revenue report including the revenue share.

14. The computer-readable media of claim 13, wherein the computer-executable instructions further cause the processor to calculate the revenue share by dividing a number of the plurality of payment card transactions by the number of visitors.

15. The computer-readable media of claim 13, wherein the computer-executable instructions further cause the processor to calculate total merchant revenue for the merchant associated with the merchant location over the report period, based, at least in part, on the calculated revenue share and a transaction volume, wherein the transaction volume comprises the sum of each transaction amount, and wherein the revenue report further includes the total merchant revenue.

16. The computer-readable media of claim 15, wherein the computer-executable instructions further cause the processor to:
receive a number of payment cards associated with the payment processing network located within the geographic region;
receive a population of the geographic region;
determine a likelihood that a mobile device located within the merchant location during the report period is associated with a purchase made at the merchant location; and
apply a scaling factor to the total merchant revenue to calculate a scaled merchant revenue, the scaling factor calculated using an algorithm:
$$1 + ϕ \frac{( b + d )}{( a + c )} ,$$
wherein (a+c) is the number of payment cards, (b+d) is the population minus the number of payment cards, and φ is the likelihood that a mobile device located within the merchant location during the report period is associated with a purchase made at the merchant location.

17. The computer-readable media of claim 13, wherein the computer-executable instructions further cause the processor to:
determine, based on the geotemporal data, a duration of stay at the merchant location of each of a subset of mobile devices, wherein the subset of mobile devices includes each of the plurality of mobile devices located at the merchant location during the report period;
categorize a visitor associated with each of the plurality of mobile devices as one of actual consumer, passerby, and other based on the respective duration of stay, wherein an actual consumer is defined by a duration of stay above a minimum actual consumer threshold and below a maximum actual consumer threshold, and wherein a passerby is defined by a duration of stay below the minimum actual consumer threshold; and
calculate the revenue share by dividing a number of the plurality of payment card transactions by a number of actual consumers.

18. The computer-readable media of claim 13, wherein the computer-executable instructions further cause the processor to: compare the transaction data and the geotemporal data for the subset of mobile devices;
compare the transaction data and the geotemporal data for each visitor;
generate a geotemporal fingerprint for one or more of the visitors based on the comparing, the geotemporal fingerprint identifying a payment account associated with each of the one or more visitors;
use the geotemporal fingerprints to adjust at least one of:
the number of visitors at the merchant location during the report period, and
a number of the plurality of payment transactions; and
calculate an adjusted revenue share by dividing the number of the plurality of payment card transactions by the number of visitors.
